(19) United States
(12) Patent Application Publication
(10) Pub. No.: US 2006/0255553 A1
(43) Pub. Date: Nov. 16, 2006

(54) Modular equipment

(76) Inventors: Mark L. Gust, Auburn Hills, MI (US); James E. McMahon, Oakland Twp., MI (US)

Correspondence Address: Kenneth I. Kohn;KOHN & ASSOCIATES, PLLC, Suite 410, 30500 Northwestern Highway, Farmington Hills, MI, 48334, US

(21) Appl. No.: 11/406,003

(22) Filed: Apr. 18, 2006

Related U.S. Application Data
(60) Provisional application No. 60/672,292, filed on Apr. 18, 2005.

(51) Int. Cl. B62B 3/00

(52) U.S. Cl. 280/47.34

(57) ABSTRACT

Modular assembly equipment including portable machinery for performing the assembly and a controlling device for controlling the portable machinery is disclosed.

### CROSS-REFERENCE TO RELATED APPLICATIONS

This application claims the benefit of priority under 35 U.S.C. Section 119(e) of U.S. Provisional Patent Application No. 60/672,292, filed Apr. 18, 2005, which is incorporated herein by reference.

### BACKGROUND ART

1. Field of the Invention

Generally, the present invention relates to modular equipment. More specifically, the present invention relates to modular equipment for use in assembly systems, such as those used in the automotive industry.

2. Description of Related Art

In conventional assembly lines, and automotive assembly lines in particular, a continuous feed of partially completed assemblies, such as an automobile, is passed through, typically, a large number of assembly stations. Each assembly or vehicle as the case may be, typically has an instruction or build sheet associated with the particular assembly. The build sheet includes instructions as to the processes that need to be performed, and the locations to which the assembly should be transported. The build sheet is typically a print out of a computer record for a particular vehicle that is attached, directly or indirectly, to the vehicle. A vehicle also has associated with it an assembly sheet. The assembly sheet identifies the various parts or components that must be installed for the particular vehicle to which the assembly sheet is associated. Consequently, the assembly sheet identifies the parts that are to be installed and the build sheet contains the instructions as to where and what processes are to be used in putting the parts identified on the assembly sheet together.

Recently the automotive industry has embraced two disparate manufacturing technologies: just-in-time (JIT) production and mass customization.

JIT production involves the co-ordination of parts supplies to the manufacturing plant and to “line side,” or locations physically proximate to the manufacturing assembly line making parts available for installation on/in the assembly in an effort to reduce inventories and, consequently, costs. As is known in the art, JIT production may require several shipments of the same part, component, or assembly, from the supplier (which may, for example, be another plant of the assembly manufacturer, another assembly line in the same manufacturing plant, or a separate or outside parts supplier, such as the Tier I suppliers to the large automobile manufacturers). These parts shipments may and often are, due to manufacturing or delivery difficulties, delayed in their arrival at the manufacturing plant. As a result of these delays, and the associated low inventory problems, it is not uncommon for the delay in a single day's shipments or even a single shipment of parts to severely impact plant manufacturing and production schedules.

Mass customization is one of many terms to describe the process of building many variations of the same vehicle brand, on the same assembly line, having the same platform or basic vehicle chassis. Moreover, other separate vehicle brands, which may share the same platform as another vehicle but require significantly different build sheets and instructions, may also be manufactured on the same assembly in order to reduce manufacturing costs. As a result of mass customization, it is not uncommon for a single platform to spawn thousands of variations amongst a number of different vehicle brands. These variations require a corresponding number of different parts to be made available to the assembly line in order to fulfill the build sheet instructions. It should be noted that the term “parts” is used very generically to include any type of component that may be affixed, applied or otherwise impact the particular vehicle manufactured. A “part” may include, for example, the fluids, the paint type, the paint color, the wheel size, the exhaust system, the engine size and configuration, the transmission, the number of doors, the seat selection(s), etc.

To accommodate JIT and mass customization simultaneously typically requires that a large number parts be made available at a single workstation, such as for example, the sound system (radio) installation station. However, due to physical limitations in line side space, many alternative methods of manufacturing have been attempted to limit the number of parts changeovers and to ease production and production costs. That is, a parts changeover is the removal from line side of one set of parts, such as economy sound system, with a replacement, at line side, of another set of parts, such as an upgraded or luxury sound system. To limit the number of changeovers, similar vehicle brands with similar configurations are, conventionally scheduled to be manufactured in lots or groups. That is, a production schedule is developed and implemented to group together those vehicles that have a similar vehicle brand and are configured or “optioned” by the customers in a similar fashion. In this manner, the number of different parts at line side required to manufacture the vehicles of a particular lot are significantly reduced. Nevertheless, the parts at line side, whenever there is a changeover from one lot to another, must be changed to accommodate the build instructions for the next lot of vehicles. For example, when a particular station completes its operations on the last vehicle of a first lot and is about to commence performing operations on the first vehicle of second lot, the line side parts located proximate to this station typically must be changed to accommodate the vehicle lot changeover.

Difficulties with the above described assembly line and method are often encountered when a vehicle fails an inspection test and must be repaired or whenever part shortages or build changes must be implemented. As is well known in the art, partially completed vehicles, or vehicle assemblies, typically are inspected at one or more points during manufacture to identify defects. As a result of these inspections, a vehicle assembly failing inspection will, typically, be removed from the assembly line and the defect repaired. The repaired vehicle will then be re-inserted into the vehicle assembly line. As a result of the various inspections, removals from the assembly line, repairs and re-insertions, members of the lots of vehicles typically get “jumbled”. That is, a repaired vehicle may be inserted into an available position on an assembly line in the middle of a different lot of vehicles with vastly different build instructions from that of the repaired vehicle. Consequently, parts must be made available line side at the remaining workstations (that is, those workstations downstream of the insertion point) in order for the assembly of the repaired vehicle to be completed in accordance with the repaired vehicle's build instructions. This often results in the assembly line slowing down or stopping so that the parts control systems may provide the proper parts and components to the various workstations encountering this repaired vehicle. Moreover, some parts, such as paint colors and types, may require a significant delay due to any required flushing and cleaning of the paint system from the previous paint color and type. For instance, if a repaired vehicle, which is to be painted white, is inserted into a lot of vehicles to be painted red, the paint system (paint lines, booths, nozzles, etc.) must be purged, flushed and cleaned of any residual red paint prior to the painting of the repaired, and to be white, vehicle. This cleansing process may be quite time consuming.

A further difficulty encountered in the conventional assembly line results from a required build instruction change. For instance, if production targets for a particular type of vehicle are not being satisfied, it may be desirable to alter the order of the lots of vehicles on the production line. If the production targets are not being satisfied, an alternative action would be alter the build instructions of particular vehicles where possible.

A still further difficulty encountered with conventional assembly lines occurs when a particular part or component has been replaced (due to shortages, supplier replacement, change in vehicle or part specifications, etc.). In this instance, the build instructions of vehicles on the assembly may have to be altered. However, with conventional assembly lines and the paper based build instructions, this process is timely and prone to errors.

Within the assembly lines, fixed machines are positioned to assembly the desired product. The fixed machines are difficult to remove or replace, such that when there is a change in the chassis of a vehicle it requires substantial maneuvering to accommodate the changes in the assembly line. Since the machinery is expensive, it is preferable to reuse the machinery; however, this is not always possible. It would therefore be useful to develop more easily alterable machinery.

All of these difficulties translate to a need for companies in the automotive industry to continually repurchase a capital equipment portion of light secondary assembly equipment. The result of such repurchasing requires substantial capital. Often this capital, due to the specialized nature of the assembly equipment, is prematurely retired after utilization by only one program. In other words, a slight change is the design of the product being built can precipitate the need for new assembly equipment. Such a waste of capital can be a large financial strain on a company. However, there is currently no available alternative equipment.

It would therefore be useful to develop an equipment system that eliminates the wasted capital expense and be easily reused and upgraded. It would also be useful if the capital equipment included a modular machine concept where the tooling cart and control portions of the equipment can be separated using simple connectors.

### SUMMARY OF THE INVENTION

According to the present invention, the present invention provides modular assembly equipment including portable machinery for performing the assembly and a controlling device for controlling the portable machinery.

### BRIEF DESCRIPTION OF THE DRAWINGS

Other advantages of the present invention are readily appreciated as the same becomes better understood by reference to the following detailed description, when considered in connection with the accompanying drawings wherein:

FIG. 1 is a partial side view of a tooling cart of the present invention;

FIG. 2 is a partial side view of a base unit of the tooling cart of the present invention;

FIG. 3 is a front view of the chassis of the present invention;

FIG. 4 is a partial side view of a palm box assembly for use with the equipment of the present invention;

FIG. 5 is a partial side view of a hose or cable hanger for use with the equipment of the present invention;

FIG. 6 is a partial side view of a light stand for use with the equipment of the present invention; and

FIG. 7 is an overview of the electrical system for connecting the tooling cart and chassis of the present invention.

### DESCRIPTION OF THE INVENTION

Generally, the present invention provides modular equipment that can be configured for the assembly of an item and reconfigured to assemble a different item. In other words, the present invention provides a tooling cart, generally shown at 10 in the figures, which can be in communication with a chassis, generally shown at 12 in the figures. The present invention can also include software for communicating between the tooling cart 10 and chassis 12, thereby automating the device for assembly purposes. The tooling cart 10 is the device that actually performs the desired function, such that the tooling cart 10 is the specialized tooling portion of the system, while the chassis 12 is the standard system controls hardware. The chassis 12 provides much of the mechanical function control for the manner in which the tooling cart 10 is to perform. The system functions as follows: the chassis 12 has a computer or similar device included therein; the tooling cart 10 includes specific software for use in controlling the equipment placed on the tooling cart 10; when the tooling cart 10 is “plugged into” the chassis 12, the computer on the chassis uploads the software of the tooling cart 10 and the chassis 12 can then run the equipment present on the tooling cart 10.

The present invention takes advantage of the “Heavy Capital Equipment Content” of the chassis 12 and the more fixed part specialized and non-reusable nature of the tooling cart 10. The chassis 12, as a control center, can include controls hardware that can be used to universally control any machinery on any tooling cart 10. The tooling cart 10 includes the software specific to the application mounted to it and the means for supporting fixed, specific machinery that are often interchangeable with other machinery merely by constructing or deconstructing supports on the tooling cart 10. Accordingly, the chassis 12 can be used to control different tooling carts 10 and machinery by simply hooking it up to a new tooling cart the software onboard the tooling cart is automatically used by the chassis to run the particular tooling cart application. Hence, the present invention provides a flexible solution requiring reusable/upgradable control centers adapted to communicate with a potentially infinite number of tooling carts 10 and machinery.

More specifically, the tooling cart 10 is a specially designed module that performs the desired function. The tooling cart 10 can be specialized or general depending on the needs. Examples of tooling cart 10 are shown in the attached figures. The tooling carts 10 can include a computer package as well as other fixed robotic, control, or assembly related components. The tooling cart 10 is formed of a rigid material capable of providing sufficient support for the equipment that is placed thereon. The specific size do the tooling cart 10 can vary depending upon the function that the cart 10 is to perform. Examples of such materials include, but are not limited to, stainless steel and other similar metals. The tooling cart 10 can be manufactured using methods known to those of skill in the art, such as, but not limited to, welding, soldering, and affixed using standard devices such as screws and nails.

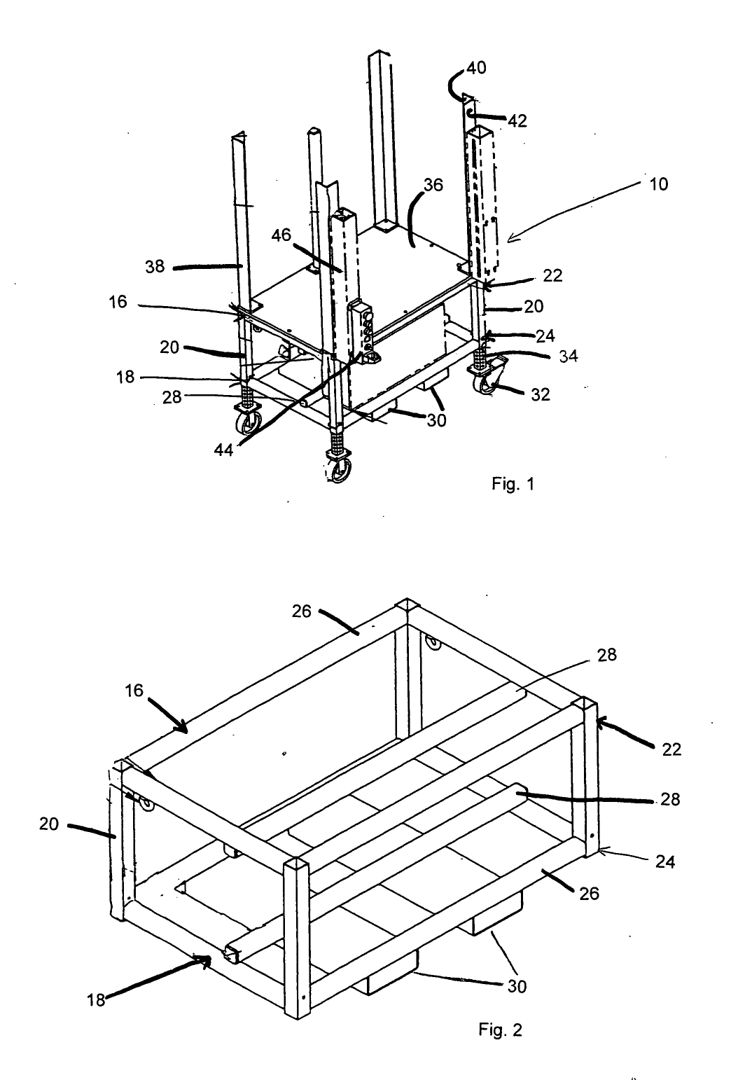

The tooling cart 10 as shown in the figures includes a base unit 14. The base unit 14 is formed of two identically shaped frames, a top frame 16 and a bottom frame 18, that are preferably rectangularly shaped. The frames 16,18 are positioned on top of one another and separated via spacing bars 20. Each spacing bar 20 has a top end 22 and a bottom end 24. The top end 22 is affixed to the top frame 16 and the bottom end 24 is affixed to the bottom frame 18, thereby forming a box that is the base unit 14 as shown in FIGS. 1 and 2. Each frame 16,18 is formed of at least four bars 26 (for the top frame 16) and 26′ (for the bottom frame 18) that are rigidly affixed to one another using methods known to those of skill in the art. If necessary, additional support bars 28,30 can be attached across the frames 16,18 for increasing the stability of the base unit 14.

Alternatively, the base unit 14 can be formed as a solid, preferably rectangularly shaped unit. While the base unit 14 is preferably rectangular in shape, other shapes can also be utilized as required for the intended use of the tooling cart 10. For example, the base unit 14 can be square.

Additionally, feet 32 can be affixed to the bottom frame 18 opposite the bottom end 24 of the spacing bar 20 for supporting the weight of the tooling cart 10 and the machinery placed upon the tooling cart 10. The feet 32 can be affixed directly to the bottom frame 18 or the feet can be affixed to legs 34 that are attached to the bottom frame 18 opposite the bottom end 24 of the spacing bar 20. Alternatively, the feet 32 can be casters or other similar devices for supporting the weight of the tooling cart 10 while providing mobility to the tooling cart 10.

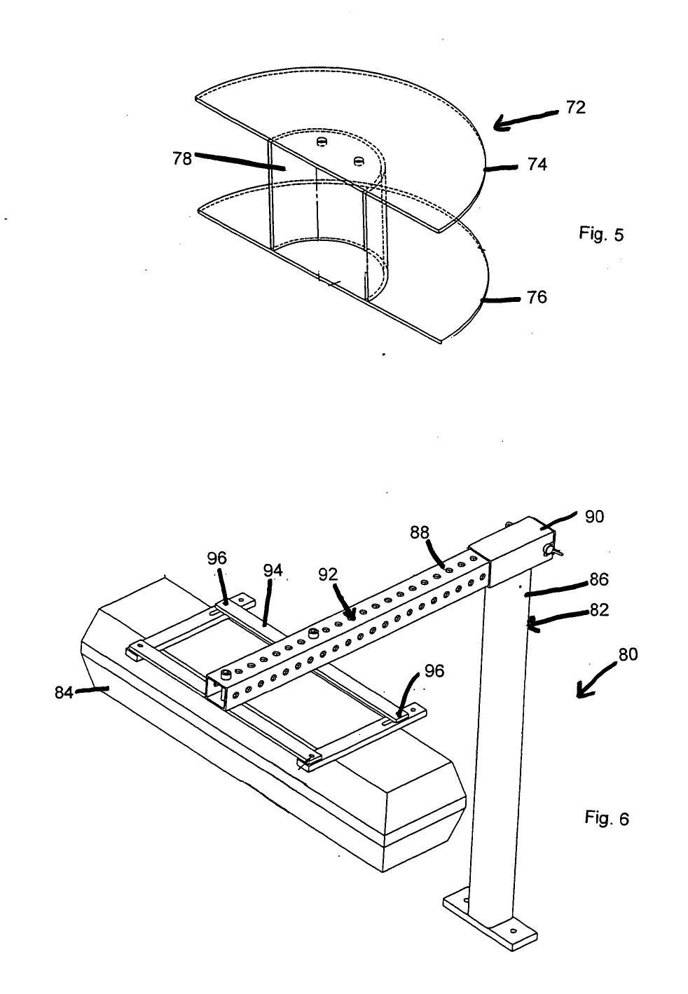

The actual machinery for performing the function is placed on the top frame 16 or otherwise operably connected to the frame 16. Various types of customization can be constructed to support most types of machinery. Preferably, the top frame 16 can further include shelf 36 that provides a solid surface on which machinery can be placed. Bracing bars 38 can be attached to the shelf. The bracing bars 38 can be used to maintain the machinery in place on the tooling cart 10. The bracing bars 38 can be as long as necessary to maintain the machinery in place. Preferably, four bracing bars 38 are utilized; however, additional bracing bars 38 can also be used without departing from the spirit of the present invention. The bracing bars 38 are V-shaped bars that are attached at corners 40 of the shelf 36. The bracing bars 38 are aligned such that the V-opening 40 is facing inward. Opposite the V-opening 40 is a flat outer surface 42. Attached to the flat outer surface 42 is a palm box assembly 44. The palm box assembly 44 is a device that is used to connect the tooling cart 10 and chassis 12. The palm box assembly 44 contains a series of buttons 48 and locks 50 (see FIG. 4), the combination of which enables the tooling cart 10 and chassis 12 to be fixedly, but reversibly, attached to one another. The palm box assembly 44 is a rectangular box through which the tooling cart 10 is attached to the chassis 12. It can be mounted with no tools on either the Right Hand or Left Hand side. The “satellite” palm button box houses the: Emergency Stop Button, Power-On Button, Reset Switch, Automatic/Manual Selector Switch and the Cycle Start Button. The Connection to the Tooling cart is completed using simple threaded twist electrical connectors. The palm box assembly 44 can either be attached directly to the outer surface 42 of the bracing bar 38 or via a second bar 46 that can be positioned between the palm box assembly 44 and the bracing bars 38.

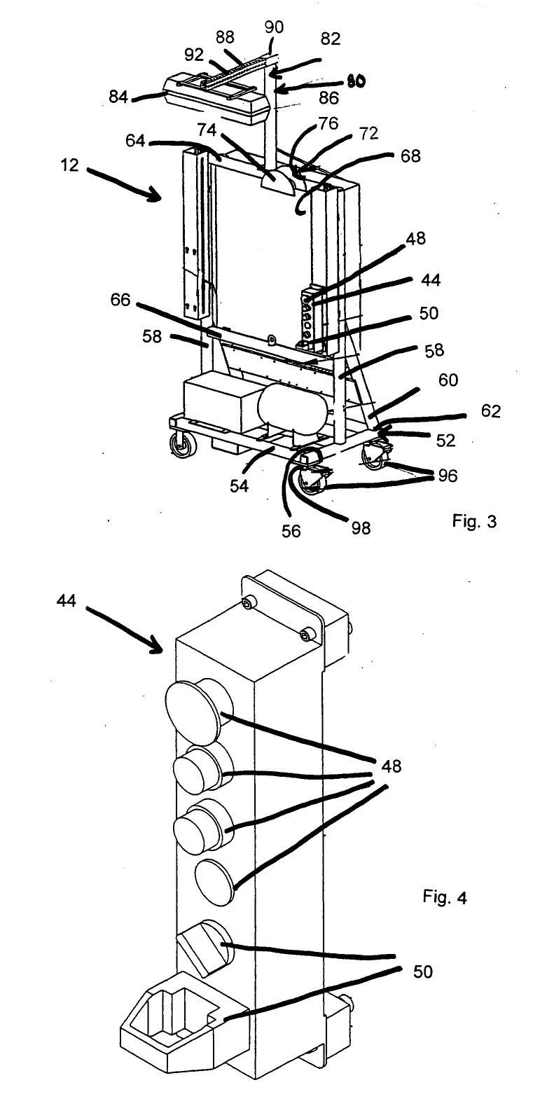

The “chassis” of the present invention is the “heavy lifting” portion of the system and is shown generally at 12 in FIG. 3. The chassis 12 can contain the communication devices for communicating and uploading the specialized software required for the function of the tooling carts. Many tooling carts can be easily and quickly “plugged” into one chassis, at different times. The present invention is therefore useful for low volume production projects where multiple tooling carts can be run using only one purchased control chassis. The chassis can be available in various grades. For example, a basic Level 1 chassis with available Stage 2, 3 and 4 controls upgrades. The more complex the tool pack is, the higher Stage upgrade required to run it. The upgrade kits enable customers to buy only what is needed “as it is needed”, never before.

The chassis 12 includes a base frame 52 formed of at least four based framing bars 54 that are attached together to form a rectangle. On a top side 56 of the base frame 52 there are attached at least two arms 58 that extend perpendicularly from the middle of two parallel framing bars 54 of the base frame 52. Bracketing arms 60 brace the arms 58 by attaching both to the arms 58 and a corner 62 of the base frame, thereby forming a right triangle with the base frame 52 and arm 58. Between the arms 58, horizontal framing bars 64,66 are positioned, thereby creating a vertical frame 68. A solid backing 70 can be affixed to the vertical frame 68, but such a backing is not required in order for the chassis 12 to function as disclosed herein.

A hose or cable hanger 72 can be attached to one of the framing bars 64. The hose hanger 72 is formed of two semi-circular pieces of material 74,76 that are separated from one another by a semi-circular separation piece 78 as shown in FIG. 5. The hose hanger 72 is preferably screwed together, but can be affixed using other means known to those of skill in the art.

A light stand 80 can also be affixed to one of the framing bars 64. The light stand 80 is preferably an L-shaped arm 82 for holding a light 84. More specifically, the L-shaped arm 82 is formed of two straight arms 86,88 that are connected via a bracket 90. Preferably, the arm 88 includes an adjustment device 92 that enables the location of the light 84 to be altered. The light 84 is attached to the arm 88 via a mounting device 94. As shown in FIG. 6, the mounting device is attached to the light 84 via screws 96.

The chassis 12 also includes a palm box assembly 44′ including buttons 48′ and locks 50′ that are compatible with the palm box assembly 44 on the tooling cart 10. As stated above, the palm box assembly 44′ functions to connect the tooling cart 10 to the chassis 12.

Additionally, feet 96 can be affixed to the base frame 52 opposite the arms 58 of the vertical frame 68 for supporting the weight of the chassis 12 and the machinery placed upon the chassis 12. The feet 96 can be affixed directly to the base frame 52 or the feet 96 can be affixed to legs 98 that are attached to the base frame 52 opposite the bottom end 24 of the spacing bar 20. Alternatively, the feet 96 can be casters or other similar devices for supporting the weight of the chassis 12 while providing mobility to the chassis 12.

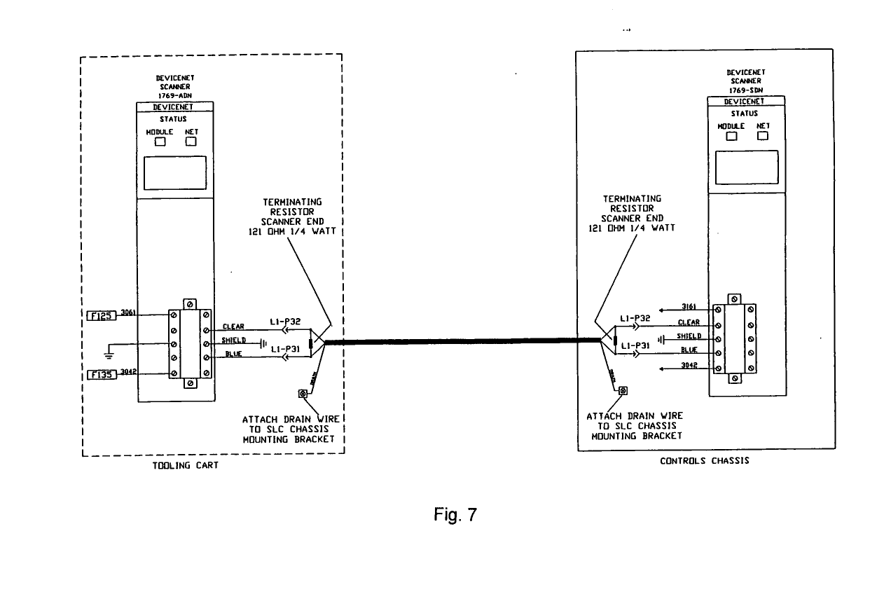

The chassis preferably communicates to the tooling carts using industrial Programmable Logic Controllers (PLC), remote inputs and outputs, discrete inputs and outputs and other Allen Bradley device net type controlling devices, however other methods of communication can be used without departing from the spirit of the present invention. The tooling carts can all include a small PLC that contains the software and machine logic required to properly operate the tooling mounted to the cart. When the tooling cart is docked to the chassis the chassis PLC searches and uploads the software from the tooling cart PLC. This logic is used in the larger more powerful chassis PLC/remote inputs and outputs to run the installed tooling cart during production operations. When the two pieces are later disconnected the software program is retained only in the tooling cart, and the chassis PLC readies itself for the next tooling cart and its software. The electrical connections between the tooling cart and chassis are generally shown in FIG. 7, but alternative connections can be used without departing from the spirit of the present invention.

The software can control communication between the chassis and the various or select components of the tooling cart. The software can control general robotic operations and additional software can be added or otherwise made available for specific robotic or other assembly related operations.

Buyers of the modular equipment of the present invention can easily and inexpensively recover/reuse the capital portions of their automated machinery with “un-plug” technology that requires no tools. The chassis is un-plugged from the specialized tooling. The specialized tooling can be stored for use later. The chassis is then available for other specialized tooling carts. The carts are designed to mate with the chassis. There is a basic controls system that has been designed to handle the majority of light automation projects. When additional control power is needed the modular chassis can be quickly and affordably up-graded on-site by technicians.

Also provided by the present invention is a tracking system. The tracking system tracks and maintains records of the location of the chassis and tooling cart and ensures optimization of the machines. The tracking system is responsible for record keeping of all modular equipment specifics: location, pm, specifications, utilization, models being run, projected volumes, release information, tool packs at that facility, phase Level of each machine and each tool pack. Example: Plant A may have an upgraded to Stage 3 chassis running a simple Level 1 tool pack. Plant B may be buying a phase 3 tool pack and have a Level 1 chassis, rather than unnecessarily upgrading the chassis. An “internal exchange” of the two units can be facilitated, therefore eliminating the need for the upgrade.

A database can also be created that contains the tracking information on each machine and tool pack. The database can contain the volumes and capacity of each cell. The end users can also use the database to be certain that they are fully utilizing their equipment before buying more.

As customers are formally awarded new business and older model vehicles are phased out or volumes decline, the tracking system can track and forecast the customers current and future equipment needs. The data is entered into the tracking system and automatic alerts are generated to forecast equipment needs. The needs can be promptly shared with the customers' purchasing departments.

The present invention can also include a quoting device for providing firm pre-negotiated standardized prices for both tool packs and chassis based simply on the requirements of the Tool Pack. Preferably the quoting device is software. The software program can generate firm pricing, and a document with a description and price of the chassis and stage level required, thus immediately generating a price. The quoting device eliminates invalid quoting and provides a more precise quote for the customer.

Additionally, the tracking software can include a physical quarterly audit. During a visit by the system provider, confirmation of database information can be collected and physical inspections made. Machine non-re-settable counters can be recorded and correlated against the database and capacity projections. The database can be updated as needed. Based on the analysis the customer requirements can be analyzed and customer needs can be determined. The turn around time for providing secondary equipment can be significantly reduced because the system can predict customer needs prior to the customer actually needing the upgrade. Standard tools can be in stock. This cuts production costs and reduces the time to hold and carry our inventories.

In operation, on an assembly line at least one chassis 12 is placed at the appropriate location. A tooling cart 10, containing machinery for completing the assembly process, is operably attached to the chassis 12. The tooling cart 10 “plugged” into the chassis 12 such that the chassis 12 can provide the tooling cart 10 with the necessary mechanics for performing the appropriate assembly process. Once the machinery has completed the assembly task, the tooling cart 10 can be removed and replaced with a different tooling cart 10 containing different machinery. When this occurs, the chassis 12 can automatically use the software from the new tooling cart 10. Alternatively, the tooling cart 10 can remain in place until there is a change in either the assembly process or in the machinery needed to complete the assembly process.

Automobile manufacturing companies have moved to only paying for the tooling portions of the machinery required to manufacture parts. The Manufacturers are responsible for the capital. When jobs end or are transferred, the ownership of this combined investment is difficult to separate. The system of the present invention solves this problem.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the described invention, the invention may be practiced otherwise than as specifically described.

What is claimed is:

1. Modular assembly equipment.

2. The equipment according to claim 1, wherein said equipment includes a tooling cart operably connected to a chassis.

3. The equipment according to claim 1, wherein said equipment is automotive assembly equipment.

4. The equipment according to claim 1, wherein said chassis controls many of the mechanical functions of said tooling cart.

5. The equipment according to claim 1, wherein said chassis can control multiple tool carts, while not at the same time.

6. The equipment according to claim 1, wherein said chassis includes hardware for communicating with the software that controls and resides on-board the tool cart in a PLC.

7. The equipment according to claim 6, wherein said chassis includes a computer for running said software.

8. The equipment according to claim 6, wherein said software is industrial Programmable Logic Controllers.

9. The equipment according to claim 1, wherein said tooling cart is a cage or housing.

10. The equipment according to claim 1, wherein said tooling cart is a fixed assembly.

11. The equipment according to claim 1, wherein said tooling cart is a portable assembly.

12. The equipment according to claim 1, wherein said tooling cart includes additional equipment.

13. The equipment according to claim 1, wherein said additional equipment is selected from the group consisting essentially of fixed robotic, control, and assembly related components.

14. Modular assembly equipment comprising:
portable machinery for performing the assembly; and
control means operably connected to said portable machinery for controlling said portable machinery.

15. The equipment according to claim 14, wherein said control means is a chassis.

16. The equipment according to claim 15, wherein said chassis includes software for controlling said portable machinery.

17. The equipment according to claim 14, wherein said portable machinery is included in a tooling cart for interchangeably moving said machinery.
